(19) United States
(12) Patent Application Publication
(10) Pub. No.: US 2025/0234835 A1
(43) Pub. Date: Jul. 24, 2025

(54) ANIMAL TRANSPORT

(71) Applicant: Christopher Alan Burton, Wellington, CO (US)

(72) Inventor: Christopher Alan Burton, Wellington, CO (US)

(21) Appl. No.: 19/046,664

(22) Filed: Feb. 6, 2025

Related U.S. Application Data
(63) Continuation-in-part of application No. 18/419,912, filed on Jan. 23, 2024.

(51) Int. Cl. A01K 1/02; A01K 1/04

(52) U.S. Cl. CPC A01K 1/0272; A01K 1/04

(57) ABSTRACT

A pet compartment includes a base, several frames, a canopy supported by the frames so as to fold and unfold upon relative pivoting of the frames, several automobile anchor connectors and a tether connector. The base has front, rear and side edges defining a footprint. The frames each include leg portions configured for pivoting relative to the base and bridge portions spanning the leg portions. The leg portions of individual frames may be coupled together through pivot plates and pivot plate caps. The automobile anchor connectors are coupled with the base near the rear edge. The tether connector is coupled with the bridge portion of one of the frames.

### CROSS-REFERENCE TO RELATED APPLICATIONS

The disclosure is a Continuation-in-Part of and incorporates herein by reference in its entirety, U.S. Non-Provisional application Ser. No. 18/419,912 filed 23 Jan. 2024 and also entitled ‘ANIMAL TRANSPORT’, pending.

### SUMMARY

The disclosure describes a pet compartment. The pet compartment includes a base, a plurality of frames, a canopy supported by the frames so as to fold and unfold upon relative pivoting of the frames, a plurality of automobile anchor connectors and a tether connector. The base has front, rear and side edges defining a footprint. The frames each include leg portions configured for pivoting relative to the base and bridge portions spanning the leg portions. The automobile anchor connectors are coupled with the base near the rear edge. The tether connector is coupled with the bridge portion of one of the frames.

The disclosure also describes a pet enclosure. The pet enclosure includes a base, a collapsible canopy and, configured to suspend the collapsible canopy above the base, first, second and third pivoting frames where the first and third frames are configured for a first amount of relative pivoting while the first and second frames and the second and third frames are configured for a second amount of relative pivoting less than the first amount.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a perspective view of an example pet compartment.

FIG. 2 illustrates a right side view of the example pet compartment of FIG. 1.

FIG. 3 illustrates a rear view of the example pet compartment of FIGS. 1 & 2.

FIG. 4 illustrates a front view of the example pet compartment of FIGS. 1-3.

FIG. 5 illustrates a top view of the example pet compartment of FIGS. 1-4.

FIG. 6 illustrates a right side view of the example pet compartment of FIGS. 1-5 in a collapsed state.

FIG. 7 illustrates a perspective view of an example sleeve or pocket suitable for use in association with disclosed pet compartments.

FIG. 8 illustrates a top view of an example unfolded section of canopy suitable for use in association with disclosed pet compartments.

FIG. 9 illustrates a detail, side view of an example automobile anchor connector suitable for use in association with disclosed pet compartments.

FIG. 10 illustrates a detail, side view of an example tether connector suitable for use in association with disclosed pet compartments.

FIG. 11 illustrates a hidden lines side view of an example pet compartment as installed in an automobile.

FIG. 12 illustrates a perspective view of another example pet compartment.

FIG. 13 illustrates a right side view of the example pet compartment of FIG. 12.

FIG. 14 illustrates a rear view of the example pet compartment of FIGS. 12 & 13.

FIG. 15 illustrates a front view of the example pet compartment of FIGS. 12-14.

FIG. 16 illustrates a top view of the example pet compartment of FIGS. 12-15.

FIG. 17 illustrates a right side view of the example pet compartment of FIGS. 12-16 in an open state.

FIG. 18a illustrates a perspective view of a first example frame and pivot plate subassembly suitable for use in association with disclosed pet compartments.

FIG. 18b illustrates a detail view of example engagement between example frames and an example pivot plate.

FIG. 19a illustrates a perspective view of a second example frame and pivot plate subassembly suitable for use in association with disclosed pet compartments.

FIG. 19b illustrates a detail view of example engagement between example frames and an example pivot plate.

FIG. 19c illustrates a detail view of example engagement between an example pivot plate and an example axle.

FIG. 20 illustrates a hidden lines side view of an example pet compartment as installed in an automobile.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Use of the terms approximately, substantially or about in conjunction with a number or range, is intended to encompass numbers or ranges that are within perhaps 3-5% of the number or range specified. Use of the terms approximately, substantially or about in conjunction with terms of orientation such as normal, perpendicular, orthogonal, parallel, collinear, vertical or horizontal is intended to encompass angles within perhaps 3-5% of those implied by the term or sufficiently close to the angle implied that an ordinary observer would not notice a difference.

Pets are commonly transported in automobiles by placing in a cargo compartment in an SUV, by placing loosely on an automobile seat or by carrying in an operator's lap. With the pet loosely placed into the automobile, there is significant risk of the pet being thrown around the vehicle during sudden acceleration, deceleration or sharp turns. Even when pets are housed in a carrier prior to placing into an automobile, the carrier may be thrown around the vehicle in these same situations. Structural elements of known carriers may also present a danger to the pet if the pet is thrown against the sides or top.

Embodiments of the disclosure substantially eliminate, or at least partially address, problems in the prior art, enabling a user to transport a pet or other small animal in or on an automobile seat in a manner that is safe for both the user and the pet while preventing damage to the automobile interior from stains, tears and/or odors. Disclosed methods and embodiments may be suitable for supporting transport of any of a variety of pets or small animals including but not limited to dogs, cats, reptiles, birds, rodents or rabbits.

Additional aspects, advantages, features and objects of the disclosure will be made apparent from the drawings and the detailed description of the illustrative embodiments construed in conjunction with the appended claims that follow.

It will be appreciated that features of the disclosure are susceptible to being combined in various combinations without departing from the scope of the disclosure as defined by the appended claims.

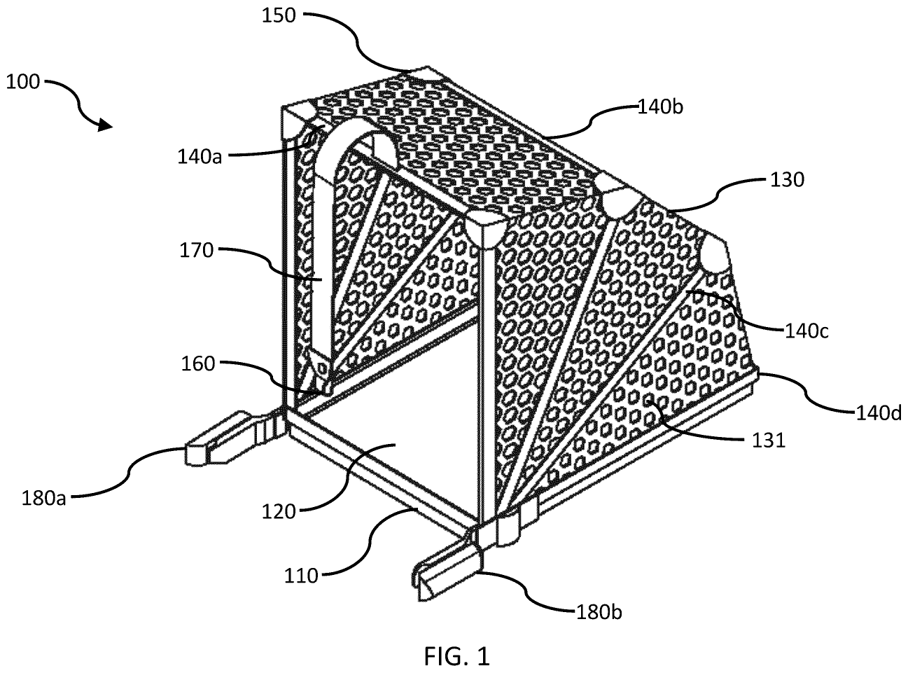

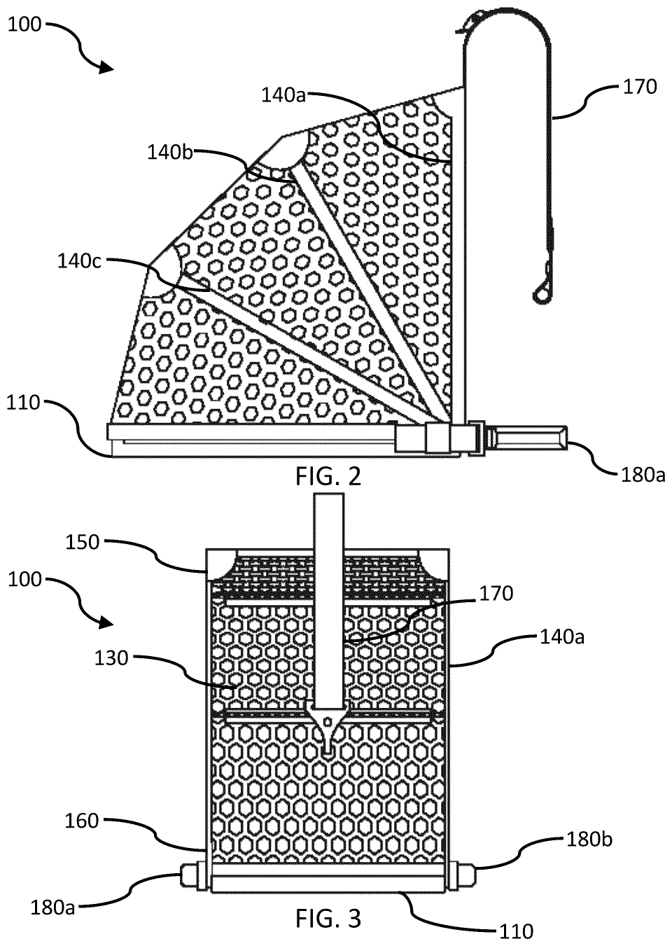

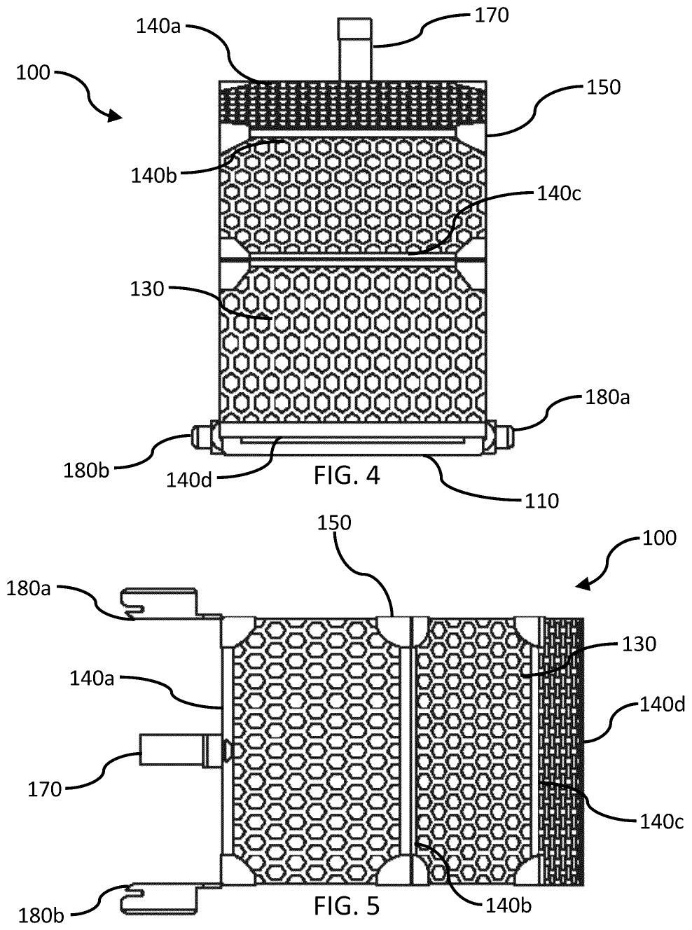

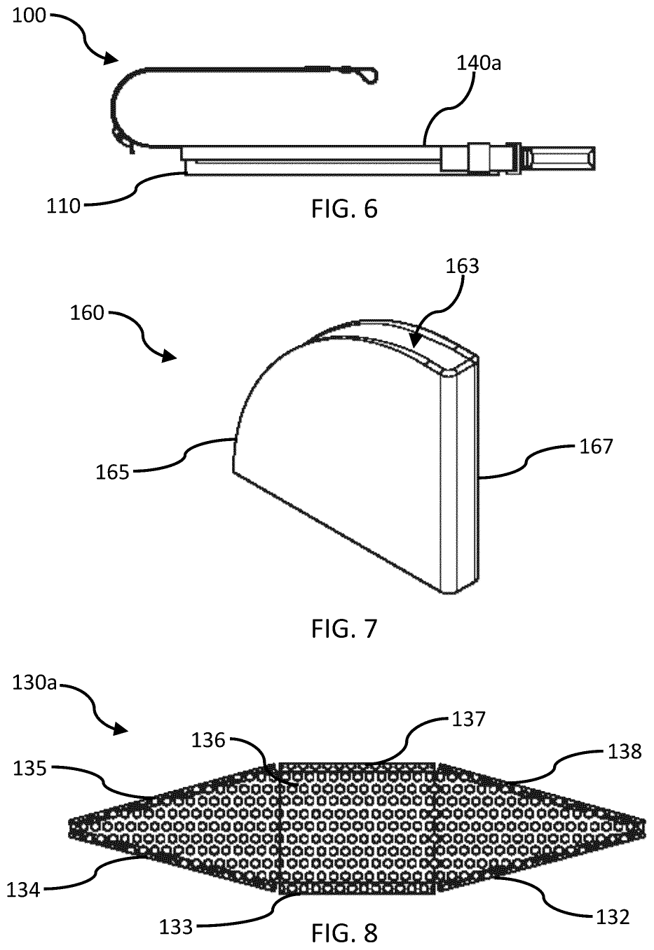

FIGS. 1-5 illustrate an example pet cubical, enclosure or compartment 100 in an unfolded or expanded state while FIG. 6 illustrates the example pet compartment of FIGS. 1-5 in a collapsed state. Pet compartment 100 includes a base 110, a number of ribs or frames 140a, 140b, 140c and 140d (collectively, 140), a canopy 130, a number of automobile anchor connectors 180a, 180b and a tether connector 170.

Base 110 may take any shape suitable for placing on a seat of an automobile for anchoring to the seat. In an example, base 110 is polygonal. In a further example, base 110 is rectangular. Similarly, base 110 may take any dimensions suitable for placing on the seat of an automobile. In an example, base 110 exhibits a width of 16″ and a length of 22″. Base 110 may be formed from any of a variety of lightweight, relatively rigid, supportive materials including but not limited to plastic.

Pet compartment 100 may further include a foam pad 120 contained by base 110. A zippered sleeve may be provided surrounding pad 120 for removal and washing or cleaning in the event of soiling or staining.

Canopy 130 is collapsible and configured for supporting or suspending above base 110, for example, by frames 140 so as to unfold or expand upon relative pivoting of frames 140 in a first direction and to fold or collapse upon relative pivoting of the frames in a second, opposite direction.

Frames 140 include leg portions pivotably coupled to opposing sides of base 110 near a rear side of base 110 and bridge portions spanning the leg portions and the width of base 110. Frames 140 may have a common pivot axis or may rotate as though they have a common pivot axis. In an example, the leg portions of frames 140 are coupled to the sides of base 110 by a sleeve or pocket joint 160 (FIG. 7) in the form of a circular segment which constrains the leg portions to generally pivoting within a plane of the leg portions and within an arc 165 of approximately 90 degrees. By its approximate 90-degree sweep, arc 165 may sweep through between perhaps 87 degrees and 93 degrees and will otherwise appear to sweep through 90 degrees to an ordinary observer. Circular segment pocket 160 may be open along the arc and a straight bottom edge at 163 while being closed along a rear straight edge 167 defining one limit of the arc.

Pet compartment 100 may include any number of frames 140 suitable for securely supporting canopy 130 above base 110. In an example, there are four frames—one passive frame 140d resting or confined to base 110 and three active frames configured for pivoting between base 110 and an angle dictated by the position at which they are affixed to canopy 130. Frames 140 may be coupled with canopy 130 at a variety of points along a front-to-rear length thereof.

Pivoting of each of frames 140 may be limited according to the number of frames and where each frame is coupled along the front-to-rear dimension of canopy 130. The pivoting frames 140 may include a first frame 140a configured to pivot a first amount between a position collapsed against base 110 to a first extended position. In an example, first frame 140a forms an opening into the compartment and pivots through an angle of approximately 90 degrees.

Frames 140 may include a second frame 140b configured to pivot a second amount less than the first amount between a position collapsed against base 110 to a second extended position. In an example, second frame 140b pivots through an angle of approximately 60 degrees.

Frames 140 may include a third frame 140c configured to pivot a third amount less than the second amount between a position collapsed against base 110 to a third extended position. In an example, third frame 140c pivots through an angle of approximately 30 degrees between a first position collapsed against base 110 and a second position.

The angle through which each of frames 140 pivots during expansion or collapse of canopy 130 may be an even division of the total pivot angle of the first or furthest pivoting frame by the total number of frames. As such, in a case of five frames, a first frame may still pivot 90 degrees while a second frame pivots 67.5 degrees, a third frame pivots 45 degrees and a fourth frame pivots 22.5 degrees. However, in some examples, the angle of rotation between pairs of frames 140 may not be equal.

Frames 140 may be formed from any of a variety of lightweight, durable, resilient materials including but not limited to lightweight metal, wood, plastic, fiberglass or combinations thereof. In an example, frames 140 may be comprised of a number of rods sewn into sleeves of canopy 130 and sandwiched between two layers of tape. Pet compartment 100 may further include a number of corner reinforcements 150 coupled with frames 140 where leg portions meet bridge portions.

Frames 140 may have a shape matching or partially matching a footprint of base 110 so that they are capable of neatly collapsing onto base 110. In an example, frames 140 may be rectangular to match a rectangular base 110.

Second frame 140b may further include a ceiling extender (not visible) to increase the overall height of pet compartment 100 allowing some adjustment of compartment size in accordance with pet size.

Referring to FIG. 8, canopy 130 may be formed from a number of hexagons 130a cut from a nylon mesh and merged along their forward and/or rearward edges. The three forward edges of each hexagon may include sleeve-forming flaps 132, 133, 134, while the three rearward edges of each hexagon may include sleeve-forming flaps 135, 137 and 138. Flaps 132, 133, 134, 135, 137 and 138 are configured to receive and hold leg portions and bridge portions of frames 140.

Canopy 130 may wrap around each frame 140 along the first leg portion, across the bridge portion and along the second leg portion. Thus, canopy 130 may include a width approximately equal to the sum of the lengths of two frame leg portions and the length of one the bridge portion. In its approximate equality to the sum of the lengths of the two frame leg portions and the length of one of the bridge portions, the width of canopy 130 may be slightly greater than this sum, for example, by 1-2 inches.

Canopy 130 may include a first continuous edge coupled with front and side edges of base 110 or leg and bridge portions of a passive frame resting on the base 110. Canopy 130 may further include a second continuous edge surrounding an opening at a rear of compartment 100. The two continuous edges come together at two corners near the rear corners of base 110.

Canopy 130 may exhibit a faceted clamshell shape when unfolded and/or may exhibit a faceted half arch in profile. Canopy 130 may include a number of see-through holes 131 and/or a number of small windows. Canopy 130 may be formed from any of a variety of thin, lightweight, flexible materials including but not limited to nylon, polyester, poly-cotton or combinations thereof.

In another embodiment, canopy 130 may further include at least an adjustable port window (not visible).

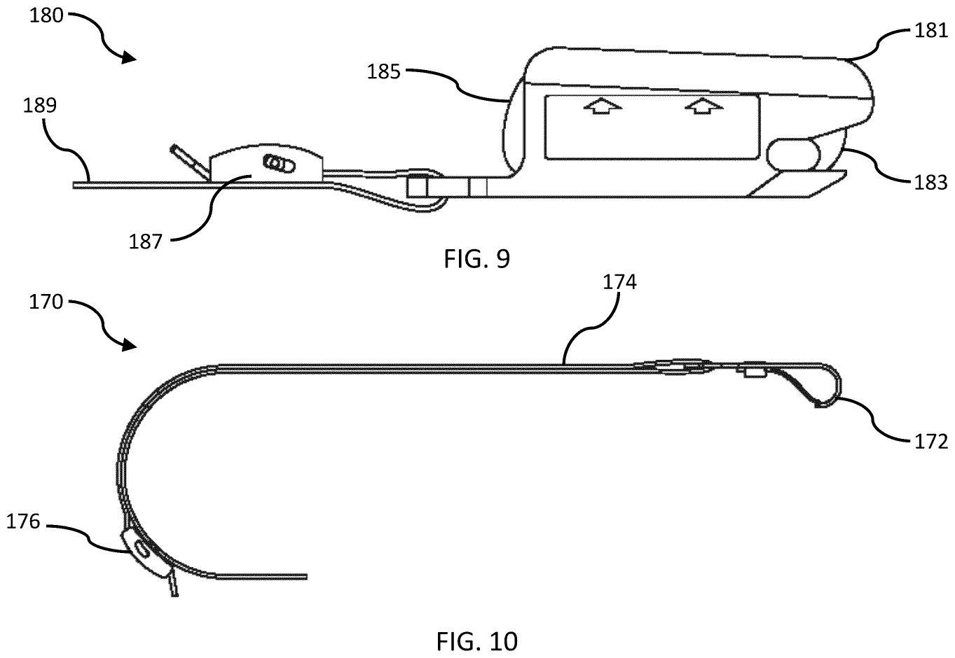

Referring to FIG. 9, automobile push-type lower anchor connectors 180a and 180b (collectively, 180) are coupled with base 110 at the rear side, for example, by webbing 189. Automobile lower anchor connectors 180 include a first buckle 181 having a gripping hook 183 and a release button 185 so as to be configured to couple with an anchor in the automobile seat bight which might otherwise be used to anchor a child car seat. The distance of automobile lower anchor connectors 180 from base 110 may be adjustable with a sliding buckle 187 so that pet compartment 100 may be secured to an automobile seat anchor in accordance with the preferred distance and/or in accordance with the preferred amount of constraint on movement of pet compartment 100.

Referring to FIG. 10, hook-type tether connector 170 may be coupled with the bridge portion of one of frames 140 (FIGS. 1-5) and include a hook clip 172 coupled to webbing 174. Distance of hook clip 172 from the frame to which it is coupled may be adjustable with a buckle 176 to shorten or lengthen webbing 174. The length of webbing 174 may be adjusted in accordance with the distance of the push-type automobile lower anchor connectors from base 110, the preferred distance of pet compartment 100 from the seat back and/or the preferred constraint on movement of the pet compartment.

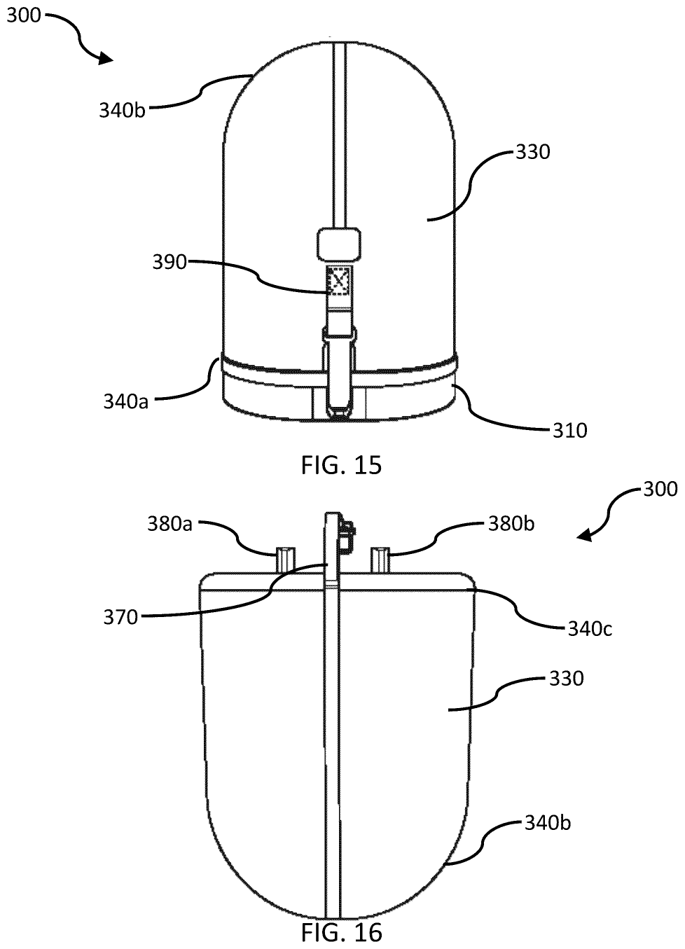

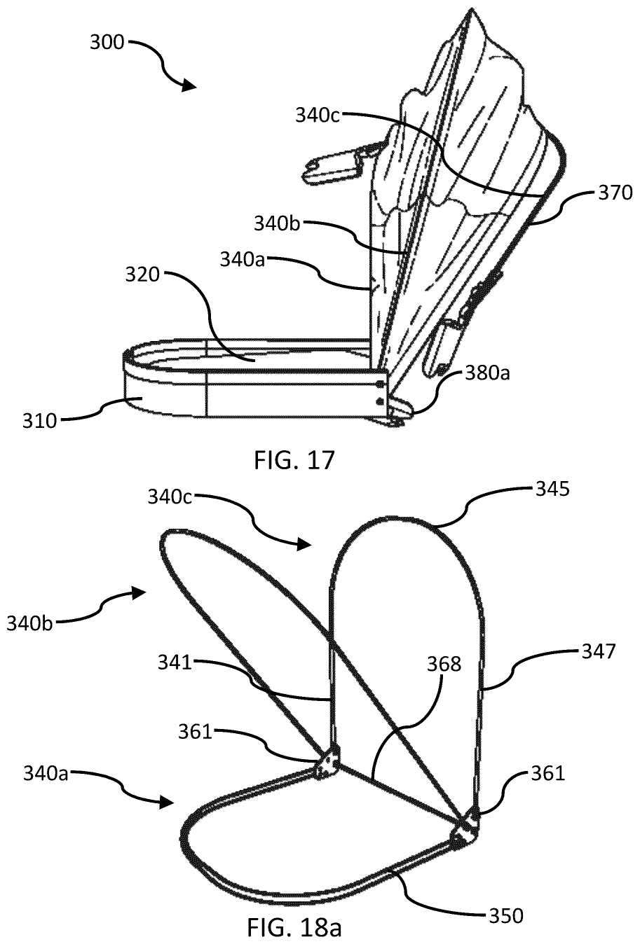

FIGS. 12-16 illustrate another example pet cubical, enclosure or compartment 300 in an unfolded or expanded state while FIG. 17 illustrates the example pet compartment of FIGS. 12-16 in an open state. Pet compartment 300 inclues a base 310, a number of ribs or frames 340a, 340b and 340c (collectively, 340) and a canopy 330. A number of automobile anchor connectors 380a, 380b, a tether connector 370 and a means 390 for selectively securing a first continuous edge of canopy 330 to base 310 may also be provided.

Base 310 has a floor and front, rear and side edges defining a footprint and may take any shape suitable for placing on and/or anchoring to a seat of an automobile. Similarly, base 310 may take any measurements suitable for placing on the seat of an automobile. In an example, base 310 is polygonal or polygonal with smoothed, rounded or filleted corners (FIG. 16). In a further example, base 310 is rectangular with smoothed, rounded or filleted corners and exhibits an overall width of about 16″ and an overall length of about 25″. Base 310 may be formed from any of a variety of lightweight, relatively rigid, supportive materials including but not limited to plastic.

Canopy 330 is collapsible and configured for supporting or suspending above base 310, for example, by frames 340 so as to unfold or expand upon relative pivoting of the frames away from one another and to fold or collapse upon relative pivoting of frames 340 towards one another. Folding and unfolding of canopy 330 and/or frames 340 may also be considered to open or close pet compartment 300 depending on their starting positions.

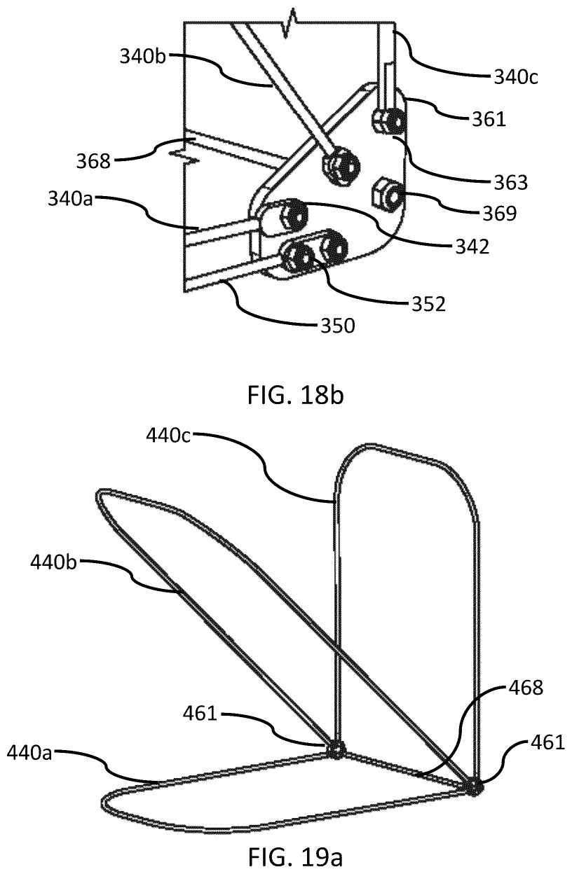

Referring to FIGS. 18a-c, frames 340 each include leg portions 341 and 347 configured for pivoting relative to base 310 and a bridge portion 345 spanning the leg portions. Frames 340 may have a shape similar to a footprint of base 310 so that they match or partially match the same. As such, they are capable of neatly collapsing onto base 310. In an example, frames 340 may be rectangular to match a rectangular base 310. In another example, frames 340 may be rectangular with smoothed, rounded or filleted corners to match a rectangular base 310 having smoothed, rounded or filleted corners. While FIGS. 18a-c depict three pivoting frames 340a, 340b, 340c, pet compartment 300 may include any number of frames 340 suitable for securely supporting canopy 330 above base 310.

Leg portions 341 and 347 of individual frames 340 may be coupled together through hubs, pivot hubs or pivot plates 361 by which the leg portions may also be pivotably coupled with base 310. Each pivot plate 361 includes a number of through-holes 363. Each of frames 340 further includes, at the end of at least one leg portion, an eyelet 342 configured for coupling with one of through-holes 363 by way of a fastener such as a bolt and nut by which each frame is configured for pivoting relative to pivot plate 361. Eyelets 342 may be integral with frame leg portions 341, 347 or may be removable.

An axle 368 is configured for receipt through or coupling with one of through-holes 363 of a pivot plate 361 at each of the axle ends and the axle thereby spans a pair of pivot plates 361. Axle 368 is coupled to pivot plates 361 with a pair of nuts 369 and offers transverse rigidity to pet compartment 300 at the rear.

When mounted to pivot plate 361, each of frames 340 may be configured for pivoting about unique axes. For example, the axis of pivot for each frame 340 may be defined by through-holes 363 around which frame eyelets 342 are received. Pivot plate 361, with its through-holes 363, also spaces each of frames 340 from the axis of axle 368 by a perpendicular distance.

Referring to FIGS. 18a-c, a reinforcing frame 350 may also be coupled with pivot plates 361 and affixed along or around the front, rear and side edges of base 310 between their upper extent and the base floor. Reinforcing frame 350 may include a double eyelet 352 at the end of each leg portion. A pair of fasteners received through the holes of double eyelet 352 and a pair of pivot plate through-holes 363 substantially prevents pivoting of the reinforcing frame 350 relative to pivot plate 361 and may prevent or restrict pivoting of the reinforcing frame relative to base 310.

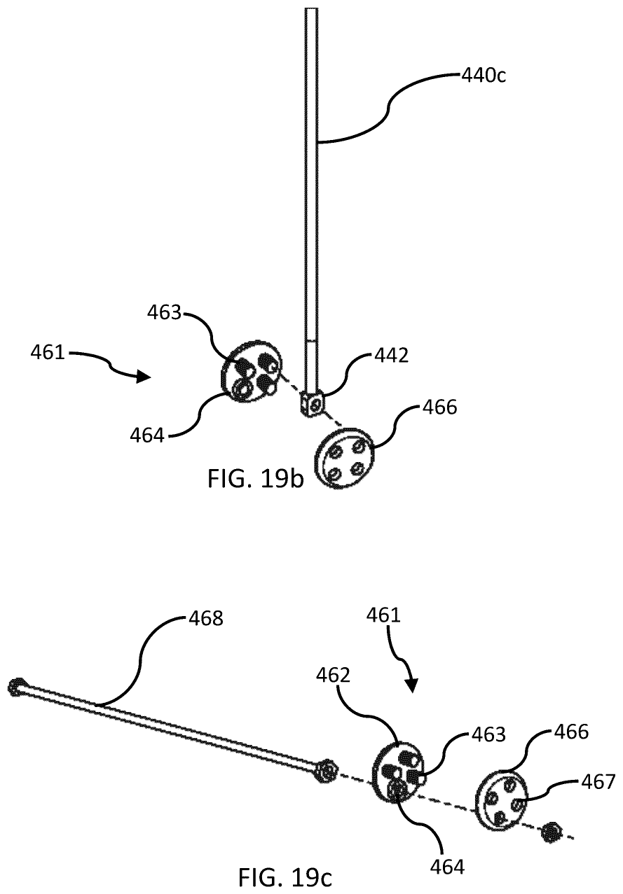

Suitable for use in association with disclosed pet compartments and interchangeably with the example of FIGS. 18a-b and/or frames 140, FIG. 19a-c illustrate a second example frame and pivot plate subassembly. Leg portions of individual frames 440a, 440b, 440c may alternatively be coupled together through a hub, pivot hub or pivot plate 461 of another design. Leg portions may be coupled to pivot plates 461 by which the leg portions may also be pivotably coupled with base 310. Each pivot plate 461 includes a plurality of pegs 463 and an axle sleeve 464. Pegs 463 and axle sleeve 464 are approximately normal or perpendicular to pivot plate inner surface 462. A pivot plate cap 466 has a plurality of holes 467 provided in a pattern matching pegs 463 and axle sleeve 464 of pivot plate 461. Each of frames 440 further includes, at the end of at least one leg portion, an eyelet 442 or 448 configured for surrounding one of pegs 463 by which each frame 440 is configured for pivoting relative to the pegs and, thereby, pivot plate 461. Eyelets 442, 448 may be integral with the frame legs or may be removable.

With leg eyelets 442 and/or 448 surrounding pegs 463 of pivot plate 461 and pivot plate cap holes 467 in receipt of pegs 463, the eyelets and lower leg portions are sandwiched between pivot plate 461 and pivot plate cap 466. As such, motion of frames 440 is constrained by cooperation between pegs 463, holes 467, pivot plate 461 and pivot plate cap 466. An axle 468 is configured for receipt through axle sleeve 464 of a pivot plate 461 at each of the axle ends and the axle thereby spans a pair of pivot assemblies. Axle 468 is coupled to pivot plates 461 and pivot plate caps 466 with a pair of nuts 469 an offers transverse rigidity to pet compartment 300 at the rear.

When mounted between pivot plate 461 and pivot plate cap 466, each of frames 440 may be configured for pivoting about first and second axes. The first axis of pivot for each of frames 440 may be unique to that frame. The second axis of pivot for each of frames 440 may be common to all of the frames or the frames may pivot as though they have a common pivot axis. For example, the first axis of pivot for each frame 440 may be defined by peg(s) 463 around which frame eyelets 442, 448 are received and the second axis, common to all frames, may be defined through axle 468 spanning pivot plates 461 to which the frames are coupled. Pivot plate 461, with its mounting pegs 463, also spaces each of frames 440 from the common pivot axis by a perpendicular distance.

Pivoting of each of frames 340 or 440 may be limited by the number of frames, by where each frame's leg portions 341 and/or 347 and/or bridge portion 345 are coupled along the front-to-rear dimension of canopy 330 and by what angle the other frames are pivoted. When pivoted together, frames 340 or 440 may pivot through an angle of approximately 100 degrees (FIG. 17). The relative angle through which each of frames 340 or 440 pivots during expansion or collapse of canopy 330 may be an even division of the total pivot angle of the first or furthest pivoting frame by the total number of frames less one. However, in some examples, the angles of rotation between pairs of frames 340 or 440 may be unequal or uneven.

In a three-frame example, the first and third (last) frames such as 340a or 440a and 340c or 440c are configured for a first amount of relative pivoting while the first and second frames 340a or 440a and 340b or 440b and the second and third frames 340b or 440b and 340c or 440c are configured for a second amount of relative pivoting less than the first amount. In a further example, when canopy 330 and/or frames 340 are expanded (FIGS. 12-16), the angle between the first and last frames 340a or 440a and 340c or 440c measures approximately 100 degrees whereas the angle between the first and second frames 340a or 440a and 340b or 440b measures approximately 50 degrees and the angle between the second and last frames 340b or 440b and 340c or 440c also measures approximately 50 degrees.

The length of each of frames 340 and 440 may differ in accordance with the number of frames and/or the desired position of the respective frames in either expanded or collapsed positions of canopy 330. For example, the second frame 340b or 440b may have a height greater than the height of the first 340a or 440a and third 340c or 440c frames. This enables the second frame 340b or 440b, in the extended position, to form a diagonal of a rounded rectangular prism while the first 340a or 440a and second 340c or 440c frames form edges thereof. With this arrangement, the front face of the pet compartment 300 is free of any rigid frames where a pet may forcefully contact the compartment during an abrupt stop of a vehicle in which the enclosure is being transported. This configuration further allows for more interior space within the compartment. Each of frames 340 and 440 may be configured for pivoting both towards and away from base 310 such that the frame which is being held fixed and the frames which are being rotated will depend on the starting position of the frames and the preferred direction of folding.

Frames 340 and 440 may be formed from any of a variety of lightweight, durable, resilient materials including but not limited to lightweight metal, wood, plastic, fiberglass or combinations thereof. In an example, frames 340 and 440 may be comprised of a number of rods sewn into sleeves of canopy 330 and sandwiched between two layers of tape. In another example, frames 340 and 440 are easily separated from canopy 330 so that a user may easily disassembly pet compartment 300.

Canopy 330 may wrap around each frame 340 or 440 along the first leg portion, across the bridge portion and along the second leg portion. Thus, canopy 330 may include a width approximately equal to the sum of the lengths of two frame leg portions and the length of one of the bridge portions. In its approximate equality to the sum of the lengths of the two frame leg portions and the length of one of the bridge portions, the width of canopy 330 may be slightly greater than this sum, for example, by 1-2 inches.

Canopy 330 may include a first continuous edge coupled along the leg and bridge portions of the first frame 340a or 440a and a second continuous edge coupled along the leg and bridge portions of the third frame 340c or 440c. Second frame 340b or 440b may be coupled to the canopy 330 intermediate the first and second continuous edges. Either of the first and second continuous edges may provide an opening to pet compartment 300 depending on the pivot of the frames and the arrangement of the pet compartment within its surroundings. The two continuous edges come together at two corners near the rear corners of base 310. In a further example, a closure of construction similar to the canopy itself may be provided across the third frame at the legs and include mating zippered edges to selectively open compartment 300 through the third frame 340c or 440c.

Canopy 330 may be formed from any of a variety of thin, lightweight, flexible materials suitable for forming a sheet including but not limited to nylon, polyester, poly-cotton or combinations thereof. Canopy 330 may include a number of see-through holes and/or a number of small windows. Given that canopy 330 is flexible and wrapped across the leg portions and bridge portions of each frame 340 or 440, the shape of the canopy may be somewhat dependent upon the shape of the frames. In an example, the canopy 330, when unfolded, exhibits the shape of a rectangular prism having smoothed, rounded or filleted corners and edges (FIG. 12). Canopy 330 may be formed from a number of polygons (hexagons) cut from a nylon mesh and merged along their forward and/or rearward edges in a manner similar to that described in association with the embodiment of FIGS. 1-11.

Pet compartment 300 may further include a foam pad 320 (FIG. 17) contained by base 310 and provided to the floor of the base to cushion an animal residing within compartment 300. A zippered sleeve may be provided surrounding pad 320 for removal and washing or cleaning in the event of soiling or staining.

Referring to FIG. 14, automobile lower anchor connectors 380a and 380b include a first buckle having a gripping hook and a release button so as to be configured to couple with an anchor in the automobile seat bight which might otherwise be used to anchor a child car seat. The distance of automobile lower anchor connectors 380a and 380b from base 310 may be adjustable with a sliding buckle so that pet compartment 300 may be secured to an automobile seat anchor in accordance with the preferred distance and/or in accordance with the preferred amount of constraint on movement of pet compartment 300. In an alternative design, automobile lower anchor connectors 380a and 380b may take the form of slide-type snap hooks or snap clips.

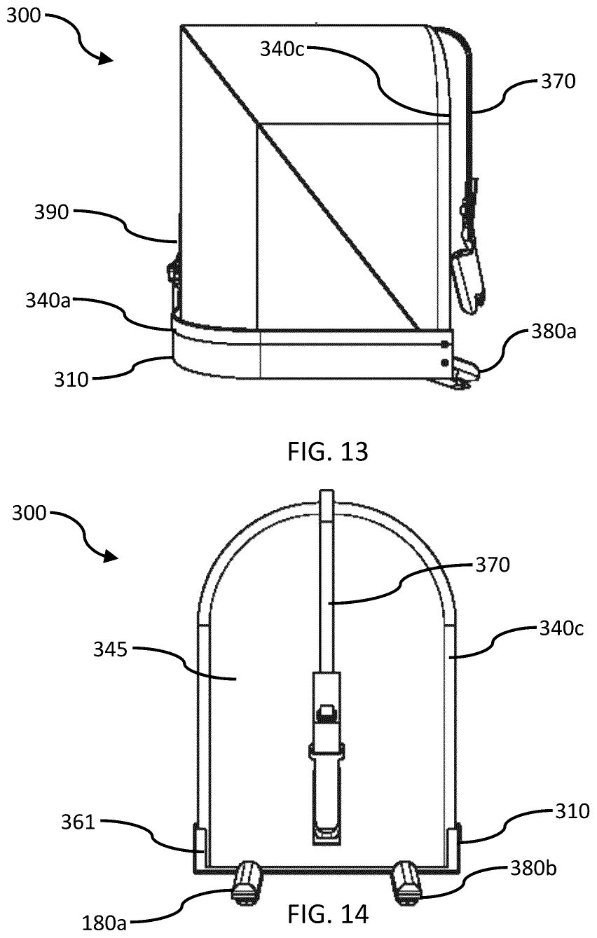

Referring to FIGS. 13 & 14, tether connector 370 may be coupled with canopy 330 or bridge portion 345 of one of frames 340 or 440. In an example, a buckle quick disconnect is coupled to the frames and/or canopy 330 by a loop of webbing and a figure-8 pass-through plate threaded onto a strap of webbing having an automobile connector at the distal end. Tether connector 370 may include a first buckle having a gripping hook and a release button so as to be configured to couple with a seat headrest post.

The distance of tether connector 370 from base 310 may be adjustable through cooperation between buckle quick disconnect, figure-8 pass-through plate and the strap of webbing so that pet compartment 300 may be secured to an automobile seat anchor in accordance with the preferred distance and/or in accordance with the preferred amount of constraint on movement of pet compartment 300 relative to the automobile. In an alternative, tether connector 370 may take the form of a slide-type snap hook or a snap clip.

Referring to FIGS. 12 & 13, pet compartment 300 may include means 390 for selectively securing, to the front edge of base 310, the first continuous edge of canopy 330 and/or frame 340 or 440 to which the first continuous edge is attached. Means 390 may include a first buckle having a gripping hook and a release button so as to be configured to couple with a seat headrest post. In an alternative, the means 390 for selectively securing may include a quick, squeeze-release buckle provided between lengths of strap. In an example, a male component of the squeeze-release buckle is coupled to base 310 by a first loop of webbing and a female component of the squeeze-release buckle is coupled to canopy 330 or a first frame by a second loop of webbing. In an alternative, the means includes a first buckle having a gripping hook and a release button.

Disclosed pet enclosures, pet compartments and/or pet cubicles may be produced in accordance with any of a variety of methods. According to an example method, a number of hexagons are cut from a nylon mesh such that each of three forward edges and three rearward edges of each hexagon include sleeve-forming flaps. A rod is sewn into a sleeve formed from each of the flaps of the three rearward edges to form a frame for each of the hexagons with six of the rods providing the frame leg portions and three of the rods providing the frame bridge portions. The hexagons are sewn together at the forward and rearward edges while leaving one free forward edge and one free rearward edge. The three coupled hexagons are formed into a canopy having two generally flat side surfaces and a faceted arch top surface.

A base is provided. The coupled hexagons are pivotably coupled to opposing sides of the base near a rear side thereof such that there is a forward hexagon, a center hexagon and a rearward hexagon. In an example, the ends of the leg portions of the rods and/or frames sewn into the hexagons are constrained in circular segment sleeves or pockets. First and second push-type automobile lower anchor connectors are coupled with the base at a rear side near corners thereof. A hook-type tether connector is coupled with a bridge of the frame of the rearward hexagon.

A corner reinforcement may be applied to two corners formed between the first and second hexagons, to two corners formed between the second and third hexagons and to two corners formed at the rearward edge of the third hexagon.

The method may further include taping inside along the edges between the first and second hexagons and the second and third hexagons and taping outside along the edges between the first and second hexagons and the second and third hexagons. A foam pad may be inserted into a cover and the combination placed into the base.

According to another example method for producing a pet compartment, with a base provided, coupled hexagons are pivotably coupled to opposing sides of the base near a rear side thereof such that there is a forward hexagon and a rearward hexagon. In an example, the ends of the leg portions of the rods and/or frames sewn into the hexagons are constrained in hubs, pivot hubs, pivot plates and/or pivot plate caps.

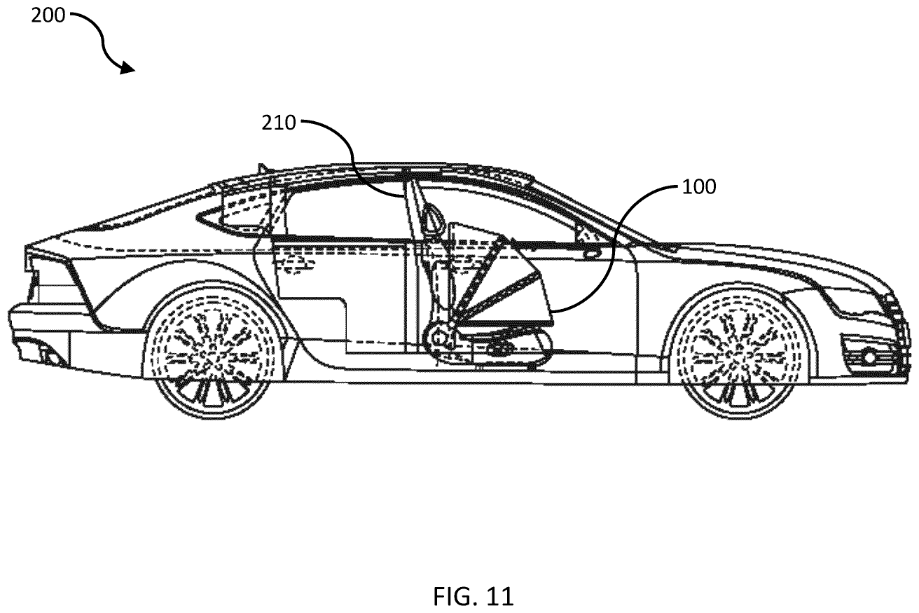

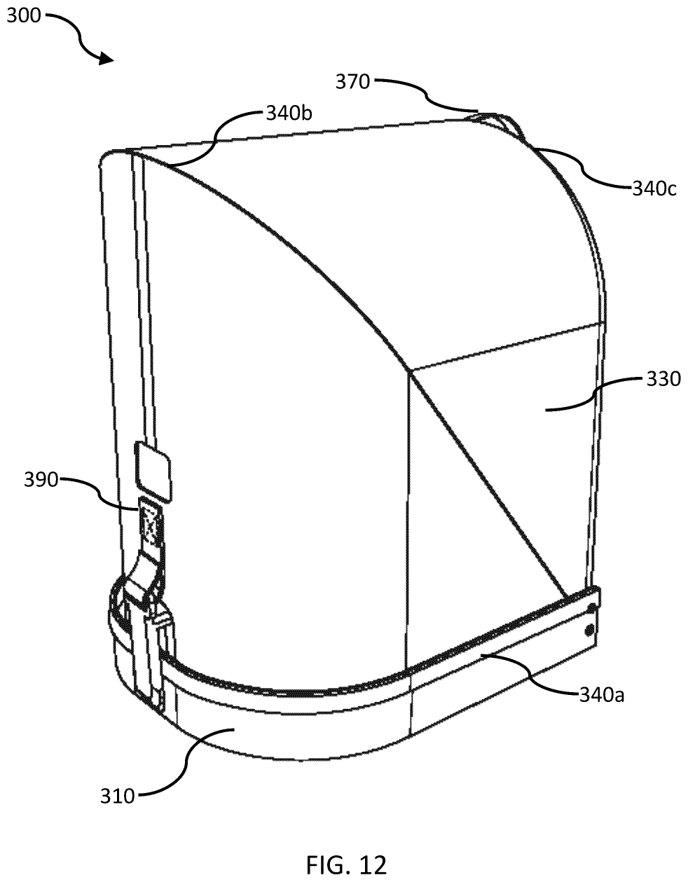

Disclosed pet enclosures, pet compartments and/or pet cubicles may be suitable for any of a variety of methods for installing the same in an automobile. In an example method, a base is placed on a seat of an automobile with a rear edge thereof adjacent to the seat back, first and second anchor connectors are coupled to anchors of the seat, a pet is placed on the base and a canopy is unfolded to cover the pet while leaving an opening above the rear edge of the base and generally within the third frame. Unfolding the canopy may further include rotating a first frame about 30 degrees, a second frame about 60 degrees and a third frame about 90 degrees. A tether connector provided to the third frame is coupled to an anchor point such as an automobile headrest post. FIG. 11 illustrates a hidden lines side view of an example pet enclosure, pet compartment or pet cubicle as installed in an automobile 200 with a tether connector coupled to the automobile headrest 210.

In another example method for installation, a base is placed on a seat of an automobile with a rear edge thereof adjacent to the seat back, first and second anchor connectors are then coupled to anchors of the seat and a tether connector is coupled between the last frame (rearward most) and an anchor point such as an automobile headrest post. For example, with both the base and the frames in an approximately horizontal orientation, first, second and third or last frames are rotated away from the base into a vertical or near-vertical orientation suitable for securing the tether connector.

A pet is then placed on the base and a canopy is unfolded from a near vertical orientation adjacent to the seat back to cover the pet while leaving an opening above the rear edge of the base and generally within the last frame. For example, a last frame may be held fixed near a vertical orientation while first and second frames and possibly additional frames are rotated away from last frame towards the base to expand the canopy over the pet.

In a further example, with each of the frames rotated to a position about 100 degrees away from the base, rotating a second frame about 50 degrees away from the last frame and rotating a first frame about 50 degrees away from the second frame or about 100 degrees away from the last frame will bring the first frame into contact with or adjacent to a top and front edge of the base effectively closing the pet compartment. The last frame is left unrotated from an orientation about 10 degrees beyond vertical and tethered to the seat back or headrest post.

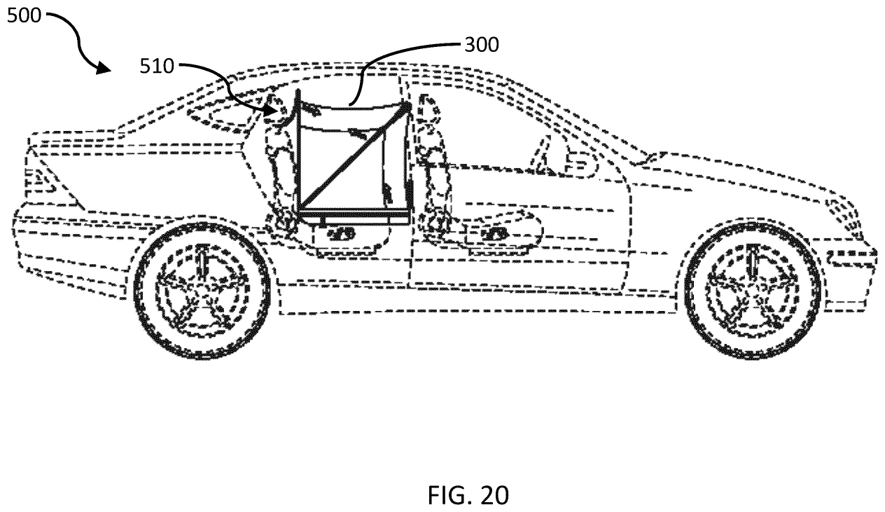

With the first frame adjacent to the base, a means such as a quick, squeeze-release buckle is coupled to selectively secure the first continuous edge of the canopy to the front edge of the base. FIG. 20 illustrates a hidden lines side view of an example pet enclosure, pet compartment or pet cubicle as installed in an automobile 500 with a tether connector coupled with a headrest post 510.

When it is time to release the pet from the pet enclosure, a user may squeeze the buckle tines or press a button with one hand to enable pivoting of the first frame and the first continuous edge of the canopy away from the front edge of the base. With the third or last frame fixed, the first and second frames may be rotated towards the third or last frame to open the canopy. In a further example, with the pet compartment in a closed configuration, rotating the first frame 100 degrees towards the last frame or 50 degrees towards the second frame and rotating the second frame 50 degrees towards the last frame will distance the first frame from the front edge of the compartment effectively opening the pet compartment.

To collapse the canopy from an expanded, closed position the compartment is untethered from the headrest post and, with the base in an approximately horizontal orientation, the first frame is held fixed in the horizontal orientation while second and last frames and any intermediate frames are rotated towards from first frame. In a further example, rotating the last frame 100 degrees towards the first frame or 50 degrees towards the second frame and rotating the second frame 50 degrees towards the first frame will all three frames adjacent to the front edge of the compartment effectively collapsing the pet compartment. Alternatively, to collapse the canopy from the folded, open position, all three frames may be rotated about 100 degrees to a horizontal or nearly horizontal position against the base.

Embodiments of the disclosure are susceptible to being used for various purposes, including, though not limited to, enabling users to transport a pet in or on an automobile seat in a manner that is safe for both the user and the pet while preventing damage to the automobile interior from stains and/or tears.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular is also to be construed to relate to the plural.

What is claimed is:

1. A pet compartment, comprising:
a base having front, rear and side edges defining a footprint;
a plurality of frames each including leg portions configured for pivoting relative to the base and bridge portions spanning the leg portions;
a canopy supported by the frames so as to fold and unfold upon relative pivoting of the frames;
a plurality of automobile anchor connectors coupled with the base near the rear edge; and
a tether connector coupled with the bridge portion of one of the frames.

2. The pet compartment as set forth in claim 1, wherein pivoting of each of the frames is limited according to where the frames are coupled along a length of the canopy.

3. The pet compartment as set forth in claim 2, wherein the canopy wraps around each frame along a first leg portion, across the bridge portion and along a second leg portion.

4. The pet compartment as set forth in claim 1, wherein the canopy comprises a first continuous edge coupled with the leg and bridge portions of a first of the plurality of frames and a second continuous edge coupled with the leg and bridge portions of a second of the plurality of frames.

5. The pet compartment as set forth in claim 1, further comprising means for selectively securing the first continuous edge of the canopy to the front edge of the base.

6. The pet compartment as set forth in claim 1, wherein the frames are coupled with the base through, in part, at least one pivot plate.

7. The pet compartment as set forth in claim 6, wherein the pivot plate further includes a plurality of through-holes.

8. The pet compartment as set forth in claim 7, further comprising an axle configured for receipt through one of the through-holes.

9. The pet compartment as set forth in claim 7, wherein each of the frames further includes, at the end of at least one leg, an eyelet.

10. The pet compartment as set forth in claim 7, wherein each of the frames is configured for pivoting relative to the through-holes.

11. A pet enclosure, comprising:
a base;
a collapsible canopy; and
configured to suspend the collapsible canopy above the base, first, second and third pivoting frames wherein the first and third frames are configured for a first amount of relative pivoting while the first and second frames and the second and third frames are configured for a second amount of relative pivoting less than the first amount.

12. The pet enclosure as set forth in claim 11, wherein the first frame has a first height, the second frame has a second height, the third frame has a third and the second height is greater than the first and third heights.

13. The pet enclosure as set forth in claim 11, wherein each of the first, second and third frames are configured for pivoting both towards and away from the base.

14. The pet enclosure as set forth in claim 11, further comprising means for selectively securing a first continuous edge of the collapsible canopy to a front edge of the base.

15. The pet enclosure as set forth in claim 11, further comprising a plurality of automobile anchor connectors configured for coupling with the base at a rear side thereof.

16. The pet enclosure as set forth in claim 11, further comprising a tether connector configured for coupling with the collapsible canopy.

17. The pet compartment as set forth in claim 11, wherein each of the frames is configured for pivoting about first and second axes.

18. The pet compartment as set forth in claim 17, wherein the first axis of pivot for each of the frames is unique.

19. The pet compartment as set forth in claim 17, wherein the second axis of pivot for each of the frames is common to all of the frames.

20. The pet compartment as set forth in claim 17, wherein each of the frames is spaced from the common pivot axis by a perpendicular distance.
